(19) United States
(12) Patent Application Publication
(10) Pub. No.: US 2024/0020759 A1
(43) Pub. Date: Jan. 18, 2024

(54) METHOD AND DEVICE FOR SEMI-5 AUTONOMOUS LOAN APPLICATION PROCESSING

(71) Applicants: GEORGE RICHARDS, SAN CLEMENTE, CA (US); TAMARA RICHARDS, Incline Village, NV (US); Antonio Velez, San Clemente, CA (US)

(72) Inventors: GEORGE RICHARDS, SAN CLEMENTE, CA (US); TAMARA RICHARDS, Incline Village, NV (US); Antonio Velez, San Clemente, CA (US)

(21) Appl. No.: 17/863,356

(22) Filed: Jul. 12, 2022

(51) Int. Cl. G06Q 40/02

(52) U.S. Cl. CPC G06Q 40/025

(57) ABSTRACT

A method and system for acceptance data inputs required for a complete resolution of analytical or documentation process, wherein at least one subprocess can be fully resolved by receipt, recognition and application of a subset of the plurality of data inputs. Some data input is applicable in more than one subprocess of the process. A resolution of the at least one subprocess may lead to an immediate resolution of the process in a negative and/or a positive finding. Resolutions of one or more subprocesses may be indicated and/or be rendered by means of a graphical user interface. A derived value result of the subprocess, a conditional result, a negative result of the subprocess, and/or a positive result of the subprocess is communicated via an electronic communications network. One or more variations of the process evaluates data required by or related to real estate transactions and/or real estate loan qualifications.

### BACKGROUND OF THE INVENTION

### Field of the Invention

This invention is generally in the field of computer-enabled data management, and more specifically the field of providing process analysis and support for managing complex clerical processes involving several parties.

### BACKGROUND ART

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

While many and various fields might benefit from application of the invention described herein, as a practical example, the disclosure focuses on the example of the complicated and time-critical process of securing a loan on a real property, wherein there is certainly a long-felt need for data management support, effective parallelization, visualization of project tasks, and improved user interfaces and communication structures, for at least the reasons mentioned herein.

One might consider the process of securing a loan on a real property from the perspective of a realty agent and/or loan agent: juggling credit checks, paperwork, building inspections, loan approvals, sudden changes in plans by the involved parties, and more. Time is of the essence in this process, and yet the large number of pieces tends to be manually managed, linear, haphazard, clunky, and thus unnecessarily complicated and difficult for all involved. Various different steps may require input from different parties, may be time-sensitive, may be either critically relevant or made redundant by another step already completed, may if unsuccessful render the whole process moot, or may even turn out differently depending on how quickly the agent can understand the situation and what needs to be done and communicate effectively with a client. These agents are juggling all of this complicated and delicate clerical work, and on top of that their clients are also relying on them for strategic guidance and support in what is often one of the biggest financial decisions in one's life, that only a knowledgeable human agent can provide.

For at least the above-noted reasons, there is a long-felt need to bring information technology more comprehensively to the aid and support of the field of real estate loan securitization, such as with a data management system and user interface for effectively managing, tracking, monitoring, visualizing, and optimizing the process of receiving and processing a variety of contingent data inputs, and the benefits of such a system at least to the particular field of completing real estate purchases and similar endeavors are obvious to see.

### SUMMARY OF THE INVENTION

Towards these and other objects of the method of the present invention (hereinafter, “the invented method”) that are made obvious to one of ordinary skill in the art in light of the present disclosure, what is provided is a method and system to enable the acceptance of a plurality of data inputs that are required for a complete resolution of analytical or documentation process (“the process”), wherein at least one subprocess can be fully resolved by receipt, recognition and application of a subset of the plurality of data inputs.

In a first preferred alternate embodiment of the invented method, an information technology network (“the network”) comprising a plurality of database servers, a user system, and a query system are applied to enable one or more of the following inventive aspects: (a.) receive a plurality of preliminary applicant information related to an applicant for a real estate mortgage; (b). instantiate a loan application schema (“the schema”) comprising a plurality of information nodes, each node adapted to receive a particular datum of a diverse plurality of information; (c.) derive at least one query from the applicant information, the at least one query formatted to request at least one particular datum of a selected one node; (d.) interrogate the network with the query; (e.) securing the at least one particular datum via the network; (f) populate the selected node with the at least one particular datum; and/or (g.) indicate to the applicant via the user system of an additional datum not yet received by the query system.

One or more certain other alternate preferred embodiments of the invented one additionally or alternatively incorporate one or more of the following inventive aspects: (a.) the Applicant providing an additional information directed to securing the additional datum; (b.) the query system deriving an additional query formatted to request the additional datum; (c). interrogating the network with the additional query; (d.) securing the additional datum via the network; (e.) populating an additional node with the additional datum; (f) indication to the Applicant via the user system of the additional datum not yet received by the query system is performed via a graphical user interface made accessible to the Applicant; (g.) a graphical user interface is made accessible to a third party as a read only access; (h.) an indication to the Applicant comprises a coloring or other visual distinction of a visual representation of the additional node; (i.) representing a plurality of nodes within a graphical user interface; (j.) indication to the Applicant via the user system of a fulfillment status of each of a plurality of nodes is made visible via the graphical user interface made accessible to the Applicant; (k.) representing each node of schema a graphical user interface made accessible to the Applicant and each fulfillment status of a plurality of nodes are visually distinguishable; (l.) representing the schema within a graphical user interface and made accessible to the Applicant; (m.) providing an account identifier as additional information; (n.) providing an account password as additional information; (o.) providing a privacy release as additional information; (p.) revising the schema on the basis of preliminary Applicant information; (q.) revising the schema on the basis of additional information; (r.) query system determining a critical path datum not yet received by the query system; (s.) indicating to the Applicant via the user system regarding the critical path datum; (t.) determining that a critical path datum is a determinative datum, wherein a received value of the datum is determinative of a loan application process; (u.) selecting a critical path datum in view of an expected lead time to receive the additional datum; (v.) indicating to the Applicant via the user system of a plurality of additional data not yet received by the query system; (w.) indicating to the Applicant via the user system of the plurality of additional data not yet received by the query system is performed via a graphical user interface made accessible to the Applicant; and/or (x.) addressing a blockchain by applying additional information that includes a blockchain memory address.

The invented method enables operators of and participants in the invented method to function at improved levels of performance under legal, regulatory and commercial constraints and demands within a context where time is of the essence. The invented method provides by novel and nonobvious aspects to develop and implement a strategy of in-process visualization of real estate loan application process made accessible via a plurality of multi-channel and multi-mode participant communications.

Certain even alternate preferred embodiments of the invented method incorporate the use of blockchain based data verification, smart contract, and/or distributed ledger retention and retrieval.

The invented method further provides the unexpected benefit of empowering users with improved, near instantaneous cognizance of situations and data fulfillment obligations. The invented method additionally hastens attention to needs that are of heightened important to be addressed quickest, e.g. by surfacing and publishing, critical paths information requirements.

Various distinguishable yet alternate preferred embodiments of the invented method additionally provide lower costs of loan processing, increased speed of closing, improved quality work product, reductions in severity and frequency of intimidating loan Applicants and potential borrowers, increased agency and comfort to loan Applicants, more positive and enabling customer user experiences, and superior fraud protection effectivity.

It is further noted that the benefits of the invented method may include reducing necessity of direct human interaction; in some embodiments, the applicant might even be the only human participant in the loop, and the system can, in certain yet other alternate preferred embodiments of the present invention, autonomously determine critical paths and query either the applicant or other third-party autonomous systems to assemble all the necessary materials, or may complete most applications autonomously and only require the intervention or assistance of a human loan agent for certain less-straightforward applications or special cases. This implementation may provide the obvious benefit of efficiency, where a labor cost of assessing loans is significantly reduced or eliminated and loan applications are completed more expeditiously without waiting on a need for a human agent's attention during business hours unless professional guidance is truly required. It is noted also that the invented method effectively gives the tech ‘first right of refusal’ for each step of the process, letting the autonomous system do the basic groundwork of ruling out reasons to decline the loan before a human agent even has to get involved in assessing the merit of an application once the basic preliminary requirements have been met.

It is noted that a reduction of the ‘busywork’ involved in the role of a human loan agent may lead to further less-anticipated benefits. A server's having the wherewithal to simply complete the easier tasks, instead of necessarily having to provide a whole interface to prompt, guide, and facilitate a human user's doing so, might provide considerable boosts in efficiency as to the use of computing resources and time. A human loan agent freed of that clerical burden might be able to handle more cases, give each case more thought and attention, provide a better customer experience to their clients, maintain healthier work habits and better quality of life with fewer ‘emergencies’ generated by some missed time-critical element, or further innovate in their field. Providing a source of automated feedback on the basic requirements of loan applications might even enable the benefit of guiding a potential applicant in planning or strengthening their application and ‘checking all the right boxes’ before formally applying, such as at an earlier point during their housing search before timing is critical, such that the applicant is enabled to be more prepared and might end up presenting a stronger and higher-quality application.

It is further noted that automating a loan approval process may provide a further benefit of reducing any human bias or perception of bias in a loan approval process, by subjecting all loan applicants to a same qualification standard codified in software used for every application indiscriminately, and providing a clear log or ‘paper trail’ (for debug purposes, if nothing else, but that is still a record) as to what was provided or found and which requirements were assessed by the software to be met or not met by the items obtained. It is noted that bias can still be codified in software processes that seem neutral, such as for instance incorporating a bias of the programmer as to which situations are necessary to account for, incorporating biases codified in relevant statutes (such as for instance accepting one form of ID over another, such that certain groups find the preferred ID easier to provide than others), or using a third party service with built-in biases of its own (such as a bias of certain credit report algorithms which are said to factor in reliable payment of a mortgage if applicable but ignore reliable payment of rent). No claim is made of providing a neutral and unbiased application process, but it is believed that this may at least help, in the ways mentioned above, as a potential benefit of the described invention.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWING(S)

The detailed description of some embodiments of the invention is made below with reference to the accompanying figures, wherein like numerals represent corresponding parts of the figures.

FIG. 1 is a block diagram presenting an electronic communications network in which the invented method might be practiced, bidirectionally communicatively coupled to a plurality of associated devices;

FIG. 2A is a hardware and software block diagram of the client device of FIG. 1;

FIG. 2B is a hardware and software block diagram of the admin device of FIG. 1;

FIG. 2C is a hardware and software block diagram of a representative one of the information source devices of FIG. 1;

FIG. 2D is a hardware and software block diagram of a representative one of the database servers of FIG. 1;

FIG. 3 is a block diagram presenting a schema data structure in the memory of the admin device of FIG. 2B, integrating a plurality of node data structures;

FIG. 4 is a block diagram presenting a query data structure as may be generated in accordance with the invented method, and presenting how the same query information might be differently formatted based on the kind of recipient being queried;

FIG. 5A is a first part of a first process chart presenting a process of gathering data and assessing loan applications;

FIG. 5B is a second part of the first process chart of FIG. 5A;

FIG. 5C is a third part of the first process chart of FIG. 5A;

FIG. 6A is a first part of a second process chart presenting a process of gathering data, assessing, and completing loan applications;

FIG. 6B is a second part of the second process chart of FIG. 6A;

FIG. 6C is a third part of the second process chart of FIG. 6A;

FIG. 7 is a drawing of a possible layout for a graphical user interface (GUI) associated with practice of the invented method;

FIG. 8A is a first flow chart from the perspective of the client device of FIG. 1, wherein the client device queries the current status of an application;

FIG. 8B is a second flow chart from the perspective of the client device of FIG. 1, wherein the client device receives a request for a piece of information, and supplies the requested item;

FIG. 9A is a first flow chart from the perspective of the admin device of FIG. 1, wherein the admin device generates a display of the present status of a specified application;

FIG. 9B is a second flow chart from the perspective of the admin device of FIG. 1, wherein the admin device requests and receives an item from another device in the network;

FIG. 9C is a third flow chart from the perspective of the admin device of FIG. 1, wherein the admin device receives and responds to a request to transmit the present status of an application to another device on the network;

FIG. 10 is a flow chart from the perspective of one of the information source devices of the network of FIG. 1, wherein the information source device receives and responds to a request for a piece of information;

FIG. 11 is a process chart presenting an aspect of the invented method, wherein the schema of FIG. 3 is built and revised based on initial and subsequent data input;

FIG. 12 is a process chart presenting an aspect of the invented method, wherein a critical path is determined based on certain criteria;

FIG. 13 is a process chart presenting an aspect of the invented method, wherein an instance of the query of FIG. 4 is generated and the network is interrogated with the generated query; and

FIG. 14 is a process chart presenting an aspect of the invented method, wherein additional information is requested and received from the applicant.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the range's limits, an excluding of either or both of those included limits is also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

The term computer storage media as used herein includes remote cloud storage assets and servers, blockchain digital assets, systems, and data servers, systems and data servers, as well as volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Additionally, it should be understood that any transaction or interaction described as occurring between multiple computers is not limited to multiple distinct hardware platforms, and could all be happening on the same computer. It is understood in the art that a single hardware platform may host multiple distinct and separate server functions.

Throughout this specification, like reference numbers signify the same elements throughout the description of the figures.

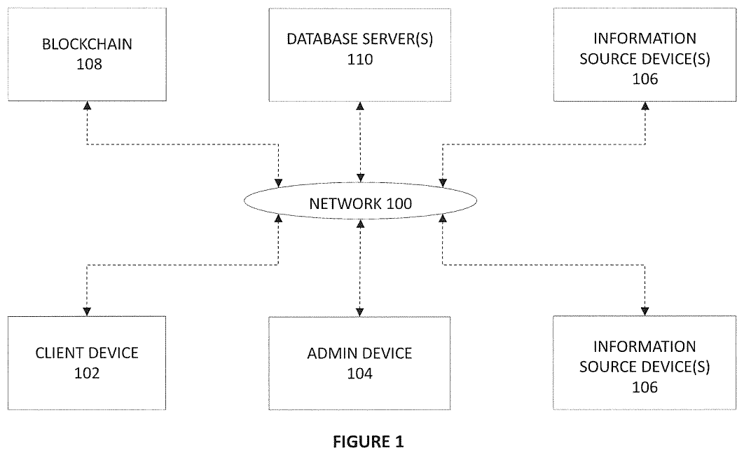

Referring now generally to the Figures and particularly to FIG. 1, FIG. 1 is a block diagram presenting an electronic communications network 100 (“the network 100”) in which the invented method might be practiced, bidirectionally communicatively coupled to a plurality of associated devices which may include a client device 102, an admin device 104, a plurality of information source devices 106, a blockchain or Ethereum server 108 (hereinafter “the blockchain 108”), and one or more database servers 110.

The client device 102 may be a computing device used by a loan applicant to interface with a service utilizing the invented method to facilitate this applicant's process for applying for a loan (such as making an initial loan request, providing materials and information as required for assessing this person's eligibility for the loan asked for, and receiving updates as needed about the status of the process), such as a personal computer, tablet, phone, or other capable device used by the applicant to access the described loan service via the network 100. The admin device 104 may be a computing device used by a professional agent responsible for processing the loan application, such as a loan agency, banker, or realtor, for accessing and managing the invented system as pertaining to one or more loan applications for which this admin is responsible, and may be pictured as the work computer (or tablet, or phone) utilized by such an agent in providing the described loan service via the network 100 to one or more applicants. In the course of the loan application process, other third-party services may need to be accessed, such as but not limited to credit reports, background checks, third-party data validation utilities, server utilities, lookups of tax information or employment information, and so on. Depending upon the services contacted, these items may be automatically generated based on a query input, or may require a request to be made to a human agent, such as an email requesting information or a form. All of these third-party resources for obtaining information, data, or required items are collectively represented as the plurality of information source devices 106. It is noted that, theoretically, there might be only one of these, depending on the context, but this is generally considered unlikely so multiple are represented. The network 100 also includes one or more database servers 110, which may be additional servers utilized by the admin's office or agency for memory storage, server utilities, and so on.

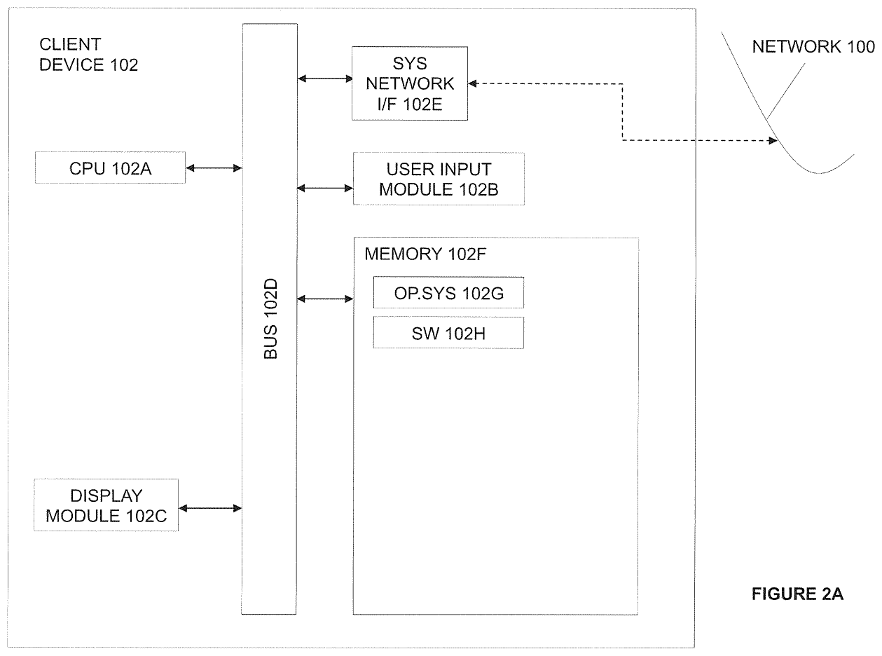

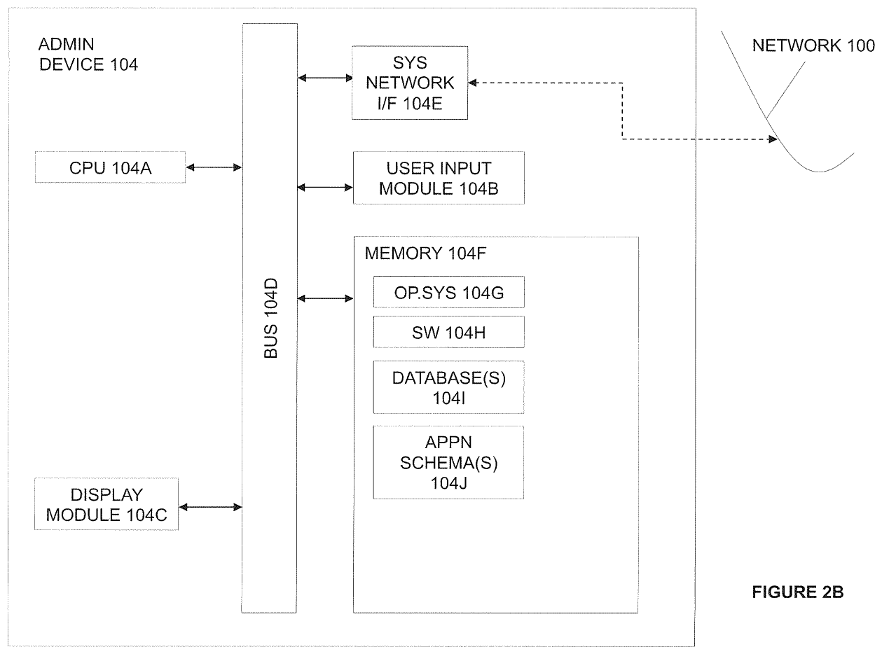

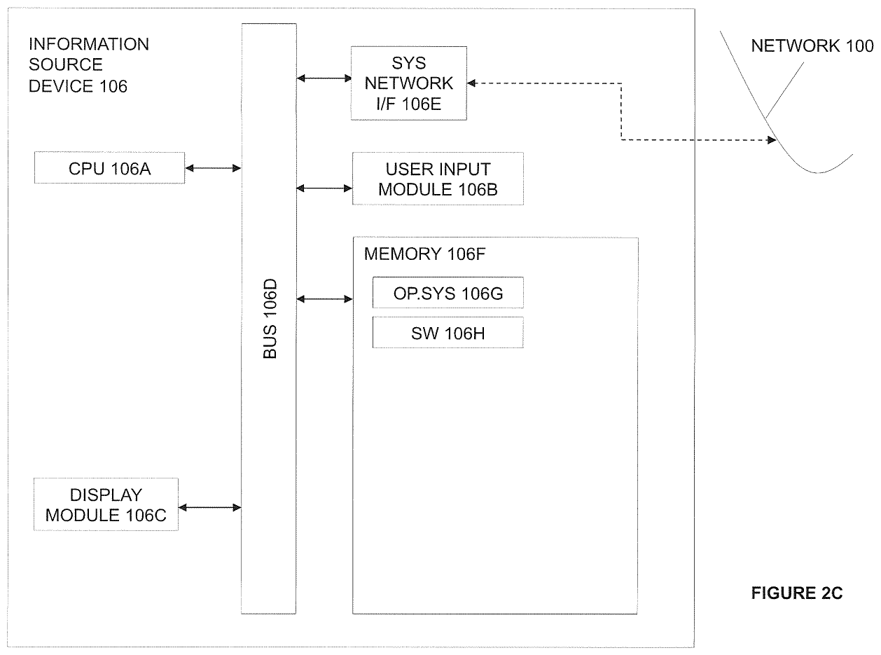

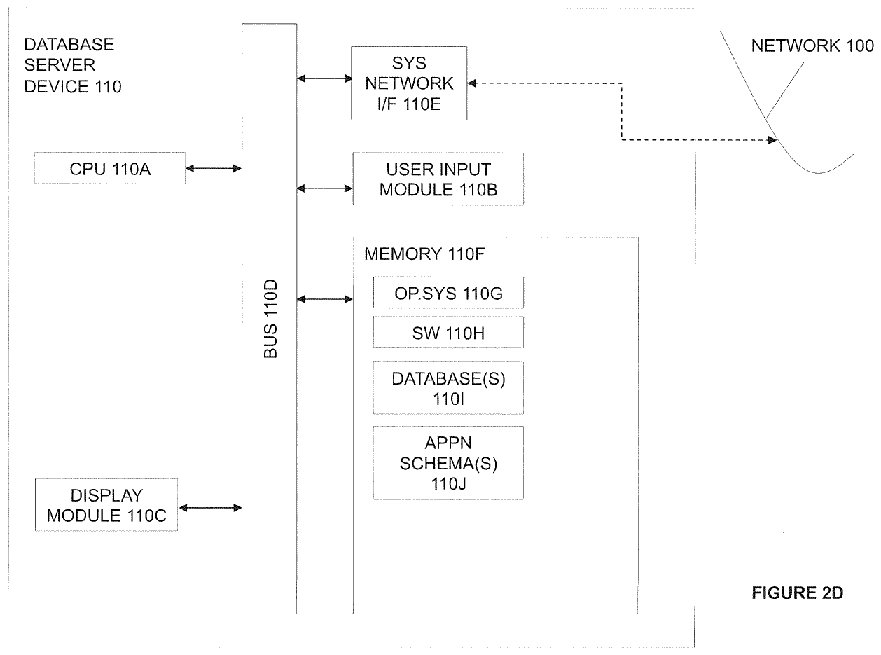

Referring now generally to the Figures and particularly to FIG. 2A, FIG. 2A is a block diagram of the client device 102 of the electronic communications network 100 of FIG. 1 and displaying together both hardware and software aspects thereof, wherein the client device 102 comprises: a central processing unit or “CPU” 102A; a user input module 102B; a display module 102C; a software bus 102D bi-directionally communicatively coupled with the CPU 102A, the user input module 102B, the display module 102C; the software bus 102D is further bi-directionally coupled with a network interface 102E, enabling communication with alternate computing devices by means of the network 100; and a memory 102F. The software bus 102D facilitates communications between the above-mentioned components of the client device 102. The memory 102F of the client device 102 includes a software operating system OP.SYS 102G. The software operating system OP.SYS 102G of the client device 102 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif; or (e.) other suitable computational system or electronic communications device known in the art capable of providing networking and operating system services as considered suitable as known in the art. The exemplary software program SW. SRC 102H consisting of executable instructions and associated data structures is optionally adapted to enable the client device 102 to perform, execute and instantiate all elements, aspects and steps as required of the client device 102 to practice the invented method in its various preferred embodiments in interaction with other devices of the network 100.

Referring now generally to the Figures and particularly to FIG. 2B, FIG. 2B is a block diagram of the admin device 104 of the electronic communications network 100 of FIG. 1 and displaying together both hardware and software aspects thereof, wherein the admin device 104 comprises: a central processing unit or “CPU” 104A; a user input module 104B; a display module 104C; a software bus 104D bi-directionally communicatively coupled with the CPU 104A, the user input module 104B, the display module 104C; the software bus 104D is further bi-directionally coupled with a network interface 104E, enabling communication with alternate computing devices by means of the network 100; and a memory 104F. The software bus 104D facilitates communications between the above-mentioned components of the admin device 104. The memory 104F of the client device 104 includes a software operating system OP.SYS 104G. The software operating system OP.SYS 104G of the client device 104 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif; or (e.) other suitable computational system or electronic communications device known in the art capable of providing networking and operating system services as known in the art. The exemplary software program SW.SRC 104H consisting of executable instructions and associated data structures is optionally adapted to enable the admin device 104 to perform, execute and instantiate all elements, aspects and steps as required of the admin device 104 to practice the invented method in its various preferred embodiments in interaction with other devices of the network 100.

It is noted that, while the diagram of FIG. 2B represents the schemas as stored in this device memory, and that may be sufficient for a sole practitioner or very small office only managing a few applications at a time all with a single computer, the inclusion of database servers 110 on the network 100 already anticipates that a larger admin's office including more agents and customers may prefer to run a server stack or rent cloud storage, dedicated memory storage for a larger database of schemas, rather than store a whole customer information database on one agent's work computer hard drive. It is further noted that the diagram of the database server(s) 110 in FIG. 2D also includes these elements as the database(s) 110I and application schemas 110J, indicating the flexibility of memory space in accordance with the computing environment of the admin enterprise. With that scalability of office computing environment stated, it might therefore be understood that the admin device 104 as presented in this context is considered a representative device of the office of the agent responsible for processing the loan, capable of accessing the schema in memory, providing information about a particular managed schema as requested by an associated applicant, editing or updating schemas as necessary, receiving and organizing required items, and performing the software processes for assessing the schema and obtaining required items from relevant sources as appropriate or directed. Whether the admin device 104 accesses the schema(s) in its own memory or uses a server for that extra storage isn't considered relevant to the invented method, as one skilled in the art of servers will recognize that there's no functional difference.

Referring now generally to the Figures and particularly to FIG. 2C, FIG. 2C is a block diagram of the information source device 106 of the electronic communications network 100 of FIG. 1 and displaying together both hardware and software aspects thereof, wherein the information source device 106 comprises: a central processing unit or “CPU” 106A; a user input module 106B; a display module 106C; a software bus 106D bi-directionally communicatively coupled with the CPU 106A, the user input module 106B, the display module 106C; the software bus 106D is further bi-directionally coupled with a network interface 106E, enabling communication with alternate computing devices by means of the network 100; and a memory 106F. The software bus 106D facilitates communications between the above-mentioned components of the information source device 106. The memory 106F of the information source device 106 includes a software operating system OP. SYS 106G. The software operating system OP.SYS 106G of the information source device 106 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif; or (e.) other suitable computational system or electronic communications device known in the art capable of providing networking and operating system services as known in the art. The exemplary software program SW.SRC 106H consisting of executable instructions and associated data structures is optionally adapted to enable the information source device 106 to perform, execute and instantiate all elements, aspects and steps as required of the information source device 106 to practice the invented method in its various preferred embodiments in interaction with other devices of the network 100.

Referring now generally to the Figures and particularly to FIG. 2D, FIG. 2D is a block diagram of the database server 110 of the electronic communications network 100 of FIG. 1 and displaying together both hardware and software aspects thereof, wherein the database server 110 comprises: a central processing unit or “CPU” 110A; a user input module 110B; a display module 110C; a software bus 110D bi-directionally communicatively coupled with the CPU 110A, the user input module 110B, the display module 110C; the software bus 110D is further bi-directionally coupled with a network interface 110E, enabling communication with alternate computing devices by means of the network 100; and a memory 110F. The software bus 110D facilitates communications between the above-mentioned components of the database server 110. The memory 110F of the database server 110 includes a software operating system OP.SYS 110G. The software operating system OP.SYS 110G of the database server 110 may be selected from freely available, open source and/or commercially available operating system software, to include but not limited to a.) a Z8 G4 computer workstation marketed by Hewlett Packard Enterprise of San Jose, California and running a Red Hat Linux™ operating system marketed by Red Hat, Inc. of Raleigh, North Carolina; (b.) a Dell Precision™ computer workstation marketed by Dell Corporation of Round Rock, Texas, and running a Windows™ 10 operating system marketed by Microsoft Corporation of Redmond, Wash.; (d.) a Mac Pro workstation running MacOS X™ as marketed by Apple, Inc. of Cupertino, Calif.; or (e.) other suitable computational system or electronic communications device known in the art capable of providing networking and operating system services as known in the art. The exemplary software program SW.SRC 110H consisting of executable instructions and associated data structures is optionally adapted to enable the database server 110 to perform, execute and instantiate all elements, aspects and steps as required of the database server 110 to practice the invented method in its various preferred embodiments in interaction with other devices of the network 100.

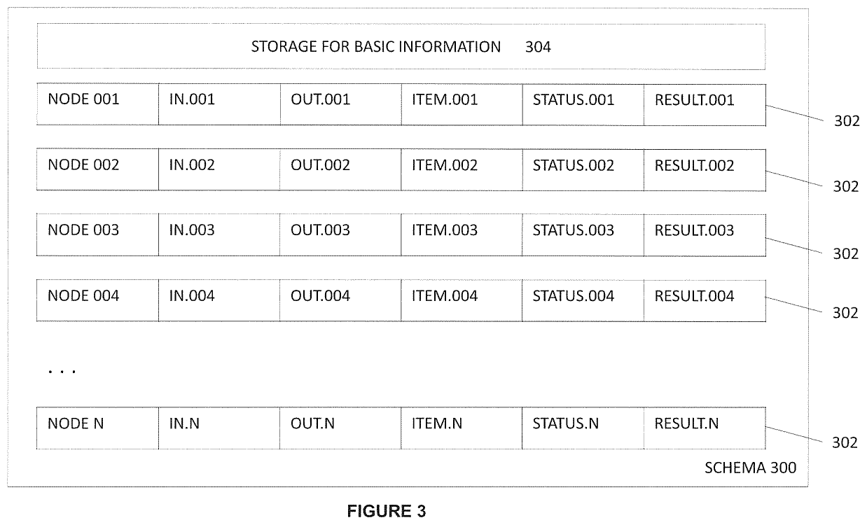

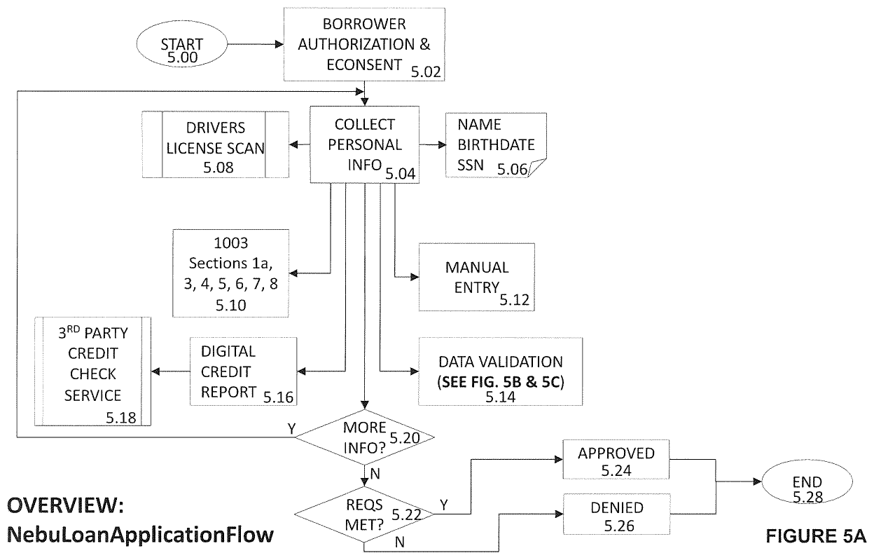

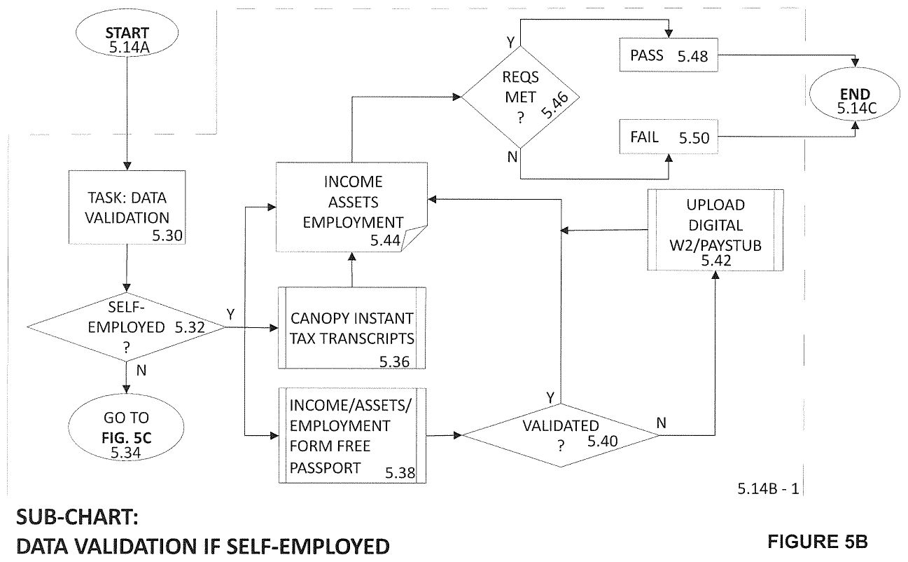

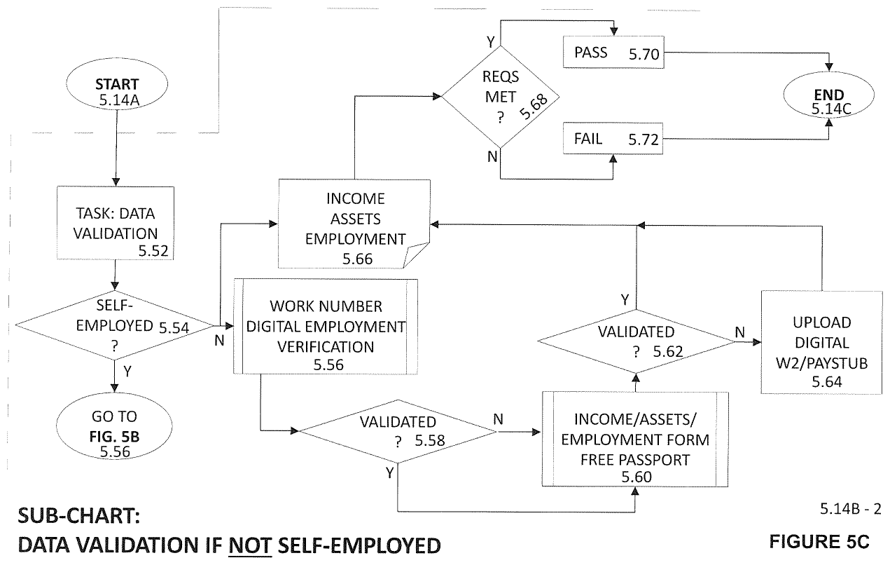

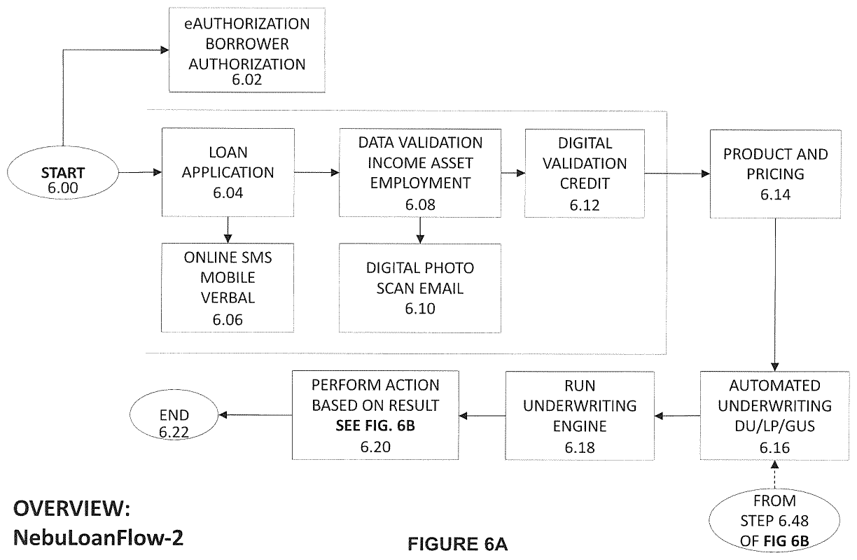

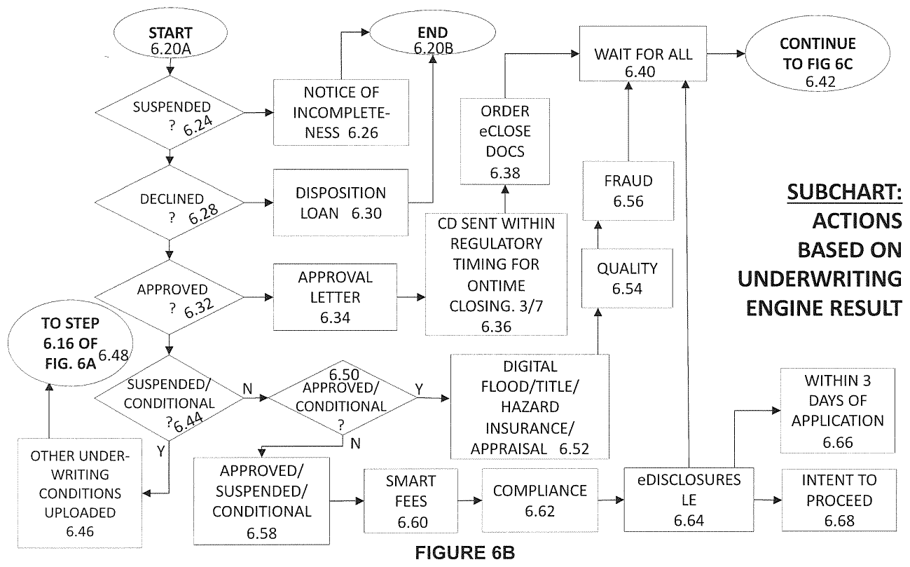

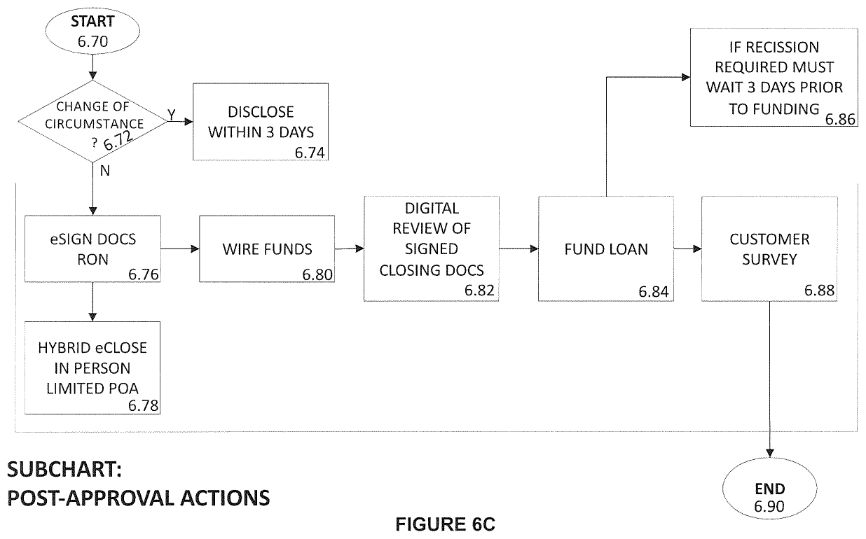

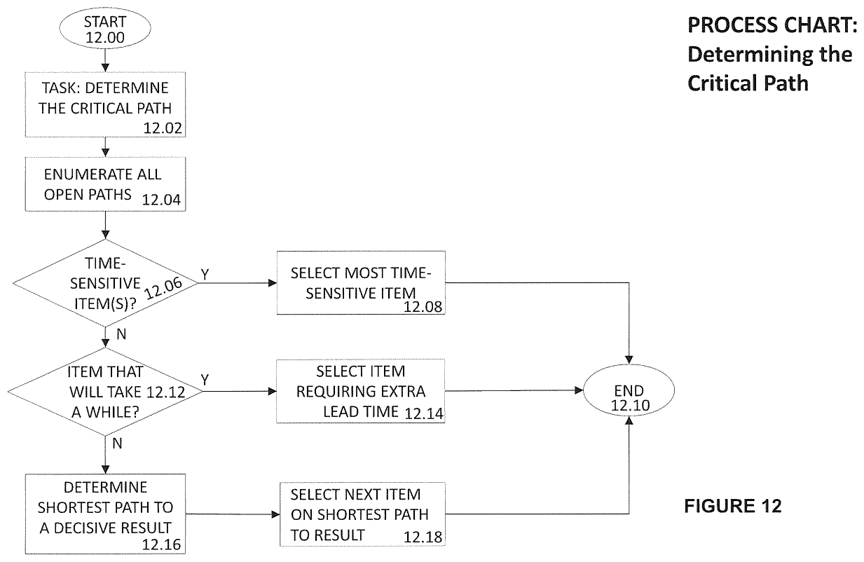

Referring now generally to the Figures and particularly to FIG. 3, FIG. 3 is a block diagram presenting a schema 300 data structure in the memory of the admin device of FIG. 2B, integrating a plurality of node 302 data structures. It is noted that a preferred visual representation of the schema might look more like a flow chart or graph of nodes 302 and connections between nodes 302, but that in computer memory such as the application schemas 104J represented in the memory 104F of FIG. 2B, an array or listing of node objects and their associations may be a more intuitive and proper storage structure; accordingly, this disclosure includes both representations. Represented here is the schema 300 pertaining to a loan application and containing a plurality of nodes 302, specifically a first node #001, a second node #002, a third node #003, a fourth node #004, and following an ellipsis signifying an indeterminate plurality of nodes in between not shown, an Nth node #N. Each of the nodes 302 comprises as some exemplary constituent data fields an IN data field IN.001-N for specifying which other node(s) 302 of the schema 300 lead into, precede, or are required as direct prerequisites for this node 302 (which inputs go to this node 302); an OUT data field OUT.001-N for specifying which other node(s) this node 302 may precede in the schema 300 (where the outputs go to); an ITEM data field ITEM.001-N specifying which item this is, which may include or comprise a text string containing the name of the item, directions for how to obtain the item, further relevant information such as deadlines, whether the item is time-sensitive, a link to or PDF of the item as submitted if the item has already been obtained and is available for perusal, and anything else that is useful information regarding the particular item of data or paperwork represented by this node 302; a STATUS data field STATUS.001-N which may include or comprise a state variable regarding whether this item is complete or incomplete, which may also provide further nuance such as indicating that the item isn't required, can't be completed yet, has been submitted but the form was incorrect, and so on; and a RESULT data field RESULT.001-N indicating what the result of completing this item might be. In further explanation of that last point, one might consider for instance an item that might decide the result of the whole loan process as opposed to one that would just be an additional contributing factor. It is noted that a key aspect of the invented method is determining critical paths and also determining when no more needs to be done in order for this loan application process to be resolved. For example, if a credit check is done first, priorities permitting, and a failure of the credit check shuts down the rest of the process as soon as the credit check results are reported, that's less work for both the loan agent and the applicant; this is a simple example of navigating what tends to be a fairly complicated network of conditional logic (see FIGS. 5A-6C), but one appreciates that storing and defining, for each node, whether resolution of this node could potentially resolve the whole process, or under what conditions resolving this node is a large step instead of a small one, is important to codify in that kind of calculation of priorities and critical paths. For more information regarding critical paths, see FIG. 12. The data storage object structure of the schema 300 may further include a quantity of basic information 304 relevant to this same application and not included in the network of nodes, such as at least identification of which application this is such that the status of the managed structure of nodes 302 can be translated to productive actions relevant to a specific associated application. The schema 300 may even serve as a data structure for accessing all information relevant to any given application, such that this data storage could include items such as the applicant's name, how to contact the applicant, the location of the home the loan is being applied for, which agent of a team is responsible for this application, and any other ‘database information’ that may be relevant for someone working on this application process to have access to in doing so.

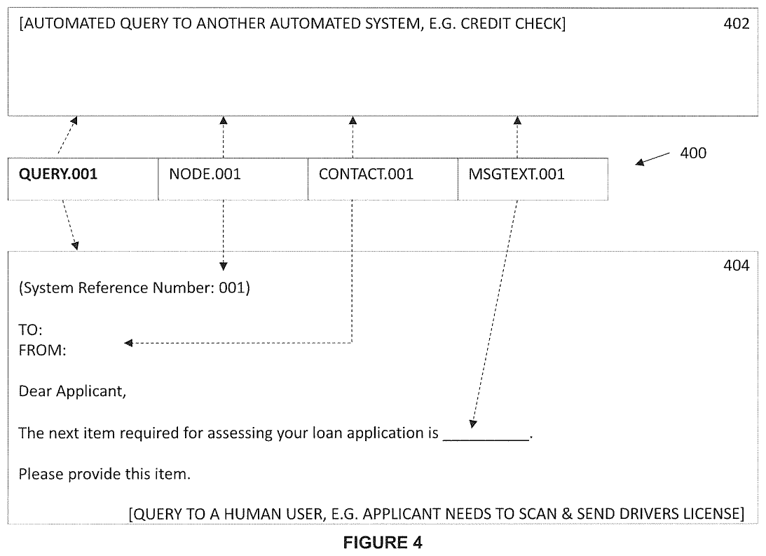

Referring now generally to the Figures and particularly to FIG. 4, FIG. 4 is a block diagram presenting a query data structure as may be generated in accordance with the invented method, and presenting how the same query information might be differently formatted based on the kind of recipient being queried. The query data structure 400 contains information regarding a first query QUERY.001, such as might be stored in memory pertaining to the schema 300 of an associated application. The query data structure 400 may further include a reference to the node NODE.001 with which this query is associated; this would be the object queried to fill in details such as the name of the item requested, by when the item is needed, and so on. The query data structure 400 may further include message text, such as whatever information not specific to the node item may be required to generate a form letter for expressing this query or to fill in a form for an automated system requesting that the automated system provide this information (for instance, one might use an automated credit check, but requesting one may still require input of identifying information in a certain format about the individual whose credit is being checked).

Referring now generally to the Figures and particularly to FIG. 5A, FIG. 5A is a first part of a first process chart presenting a process of gathering data and assessing loan applications. This chart might be considered an overview, and includes the step ‘DATA VALIDATION’ as a placeholder for the processes presented further in FIGS. 5B and 5C; one might read step 5.14 as a ‘function call’ (in software terminology) or a ‘nesting’ of these process charts. It is noted that this is atypical at best as a process chart or flowchart because these steps are not linear; one might read the charts of FIGS. 5A through 6C as an outlining of the actual requirements for a loan application which might be included in an instance of the schema 300, such that a reader can gain a background understanding of how the loan application process is structured, and get a sense of the complexity of the process and how the proposed software solution is designed with the particulars of the loan application process in mind. It is further noted that these charts are intended to paint a picture, and may not necessarily be comprehensive or exhaustive in enumerating all of the possible steps of any possible loan application process. At step 5.00, the process starts. At step 5.02, the borrower (applicant) provides authorization and eConsent; it is noted that the rest of the data gathering process might not be permitted to start until the applicant has initiated the application and consented to the data gathering process. At step 5.04, the applicant's personal information is collected for the application, specifically the personal information enumerated in steps 5.06 through 5.18. This personal information gathering may include: step 5.06, wherein the applicant manually provides information such as the applicant's name, birthdate, and social security number; step 5.08, wherein the applicant provides a scanned image of the applicant's driver's license or other ID; step 5.10, wherein information relevant to Sections 1a, 3, 4, 5, 6, 7, and 8 of an application (1003) is collected; step 5.12, wherein other data might be manually entered as required; step 5.14, wherein gathered data is validated (further detail is provided in FIGS. 5B and 5C); step 5.16, wherein a digital credit report is looked up for this applicant, and step 5.18, wherein this credit check may be done by a third-party service. The loan process cannot proceed until enough information has been entered/gathered and validated to conclusively determine whether the application is valid; in step 5.20, if not enough information has been gathered and more information can be, the process is ‘kept in a loop’ of gathering data until there is enough to proceed. It is noted that the process may not require every possible piece of data that can be gathered; this is an assessment of whether enough has been gathered to assess the validity of the application, and not necessarily whether all possible data gathering has been done. In step 5.22, it is determined whether the application is granted or rejected, based on whether the gathered data indicates that the applicant meets the requirements to qualify for the applied-for loan. If yes, then at step 5.24 the application is approved; if no, then the application is denied at step 5.26. Either way, the process ends at step 5.28.

Referring now generally to the Figures and particularly to FIG. 5B, FIG. 5B is a second part of the first process chart of FIG. 5A. Specifically, the process chart of FIG. 5B is a ‘zoomed-in’ view of the Data Validation of step 5.14, such that the entire chart of FIG. 5B might be considered as ‘nested inside’ step 5.14 of FIG. 5A. It is noted that there are two versions of this nested process, FIGS. 5B and 5C, wherein FIG. 5B is the appropriate process for a self-employed applicant, and FIG. 5C is the appropriate process for an applicant who is not self-employed. At step 5.14A, the process starts as a subprocess of step 5.14 of Figure the intervening steps of the subprocess are collectively labeled step 5.14B (note the dotted-line perimeter and lower right corner label of “5.14B-1” in FIG. 5B and “5.14B-2” in Figure indicating alternative versions of a same subprocess); and the subprocess ends at step 5.14C, returning to the rest of the process of FIG. 5A as described therein. For clarity of explanation, the sub-steps of FIG. 5B continue the element numbering pattern from the last number assigned in FIG. 5A, even though these sub-steps would all occur at step 5.14 of FIG. 5A and thus occur ‘before’ certain steps of FIG. 5A that have smaller element numbers. At step the task of data validation has been undertaken. At step 5.32, it is determined whether the applicant is self-employed; if not, then the process is redirected to FIG. 5C instead, at step 5.34. If so, multiple paths are available in terms of providing data about the applicant's income, assets, and employment, some options more direct than others. It is repeated for emphasis that one reason this process is complex and automation of managing this process is desirable is because which path or piece of data is critical can change based on what the applicant can or can't provide, the result of a third-party lookup (such as a credit check) or validation process, or something else. The process may proceed to either step 5.36, 5.38, or both for the sake of redundancy, or ‘skip ahead’ to step 5.44 and provide the necessary information about income, assets, and employment some other way, depending on the applicant and/or the circumstances; it is noted that these splitting paths will all re-converge at step 5.44, and at step 5.46 it is determined whether whatever was done in steps 5.36 through 5.44 was sufficient to meet the requirements. At step 5.36, a tax transcript is obtained, such as but not limited to a tax transcript from Canopy Instant Tax Transcripts or another similar service. At step 5.38, an income/assets/employment form free passport is utilized. At step 5.40, the passport of step 5.38 is validated; if the validation fails, at step 5.42, the additional option is provided of uploading a digital IRS W-2 form or paystub. At step 5.44, these input materials are aggregated; other data pertaining to the applicant's income, assets, and/or employment may also be gathered or entered at this point as necessary. At step 5.46, it is determined whether or not the requirements for data validation have been met by providing of the materials gathered in steps 5.36 through 5.44; if so, then the validation test is passed at step 5.48, and if not, the validation test is failed at step 5.50. Referring now generally to the Figures and particularly to FIG. 5C, FIG. 5C is a third part of the first process chart of FIG. 5A, specifically a second version of the chart of FIG. 5B covering the same scope as described above but pertaining instead to applicants who are NOT self-employed. As in FIG. 5B, the process starts at step 5.14A, comprises a series of sub-steps within a step 5.14B (version 2), ends at step 5.14C, and continues the element numbering schema where FIG. 5B left off. At step 5.52, the task of data validation is undertaken. At step 5.54, it is determined whether the applicant is self-employed; if the applicant is self-employed, the process is redirected to FIG. 5B instead at step 5.56. Else, the process continues on to assembling the necessary data regarding the applicant's income, assets, and employment; depending on the applicant or the circumstances, this process may ‘skip ahead’ to step 5.66 if appropriate, or proceed to step 5.56 wherein a work number or digital employment verification is gathered, and step 5.58, wherein this data is validated. Regardless of whether the validation succeeds or fails, an income/assets/employment form free passport may be provided next in step 5.60. If validation of the passport fails in step 5.62, a digital IRS W-2 form or paystub bay further be uploaded. At step 5.66, all provided data is aggregated, and at step 5.68, it is determined whether the provided data meets the requirements for the data validation of step 5.14. If so, the data validation test is passed at step 5.70; if not, the data validation test is failed at step 5.72.

Referring now generally to the Figures and particularly to FIG. 6A, FIG. 6A is a first part of a second process chart presenting a process of gathering data and assessing loan applications. It is noted that, as various elements of this process might be completed non-linearly and this is indeed a point regarding the utility of the present invention, sometimes a step will have multiple arrows leading to or from. It is noted that it may be useful to think of the present process chart as a mapping of elements that might be included in an instance of the schema 300 as used for tracking the process of a loan application. The process starts at step 6.00. At step 6.02, the applicant provides eAuthorization for proceeding with the application, which may include lookups of personal information or actions such as credit checks which require the authorization of the party being checked. At step 6.04, the loan application proceeds, such as, in step 6.06, by online SMS, mobile, or verbal communication. At step 6.08, data validation, income, assets, and employment are assessed, such as in step 6.10 via digital photo scans or email. It is noted that these data-gathering steps may be presented in more detail in other Figures. In step 6.12, the applicant's credit is digitally validated. In step 6.14, product and pricing is considered; what loans is this applicant eligible for, based on the assembled materials, and what can be offered? In step 6.16, automated underwriting is performed, specifically use of systems which may include the FNMAs system Desktop Underwriter (DU), FHLMCs system Loan Product Advisor (LP), and USDA system Government Underwriting System (GUS). It is noted that a later step as presented in FIG. 6B may result in going back to this point, as shown. In step 6.18, an underwriting software engine is run. In step 6.20, an action is performed based on the result produced by the underwriting engine, and the selection of these results and corresponding actions is presented in FIG. 6B, as a sub-chart (or function-call) within the preset chart. Having performed whatever action is indicated in the sub-chart of FIG. 6B, the process ends at step 6.22.

Referring now generally to the Figures and particularly to FIG. 6B, FIG. 6B is a sub-chart of the second process chart of FIG. 6A, specifically detail regarding execution of step 6.20 of FIG. 6A. It is noted that these three process charts are an adaptation of what used to be one big process chart that did not fit into the dimensions of a Figure at any reasonably legible size, and therefore it may be useful to keep in mind that this is an adaptation of a single chart that had to be split up into sections. Depending upon the result produced by the underwriting engine of step 6.18 of FIG. 6A—specifically, the possible results are SUSPENDED, DECLINED, APPROVED, SUSPENDED/CONDITIONAL, APPROVED/CONDITIONAL, or APPROVED/SUSPENDED/CONDITIONAL—different courses of action are indicated. At step 6.20A of FIG. 6B, the process starts; it is noted that the numbering 6.20A of the start step and 6.20B of the end step is a further indication that this whole process chart may be considered as ‘nested inside’ step 6.20 of FIG. 6A, but subsequent steps will simply continue with the order of numbering from the end of FIG. 6A. At step 6.24, it is determined whether the result of the underwriting engine was SUSPENDED. If so, at step 6.26, a notice of incompleteness is issued, and the process ends at step 6.20B. Alternatively, at step 6.28, it is determined whether the output is DECLINED, and if so, at step 6.30 a disposition loan may be considered. Alternatively, if the result is APPROVED, at step 6.34 an approval letter is issued, at step 6.36 a closing disclosure (CD) is sent within the regulatory timing for the ontime closing (there is a regulatory timing of a 3 or 7 day waiting period), and at step 6.38, eClose Docs are ordered. Step 6.40 is a ‘hold’ step to wait for all necessary materials to come in, before proceeding to FIG. 6C, which is the post-approval process, at step 6.42. Alternatively, at step 6.44, it's determined whether the result is SUSPENDED/CONDITIONAL. If so, at step 6.46 other underwriting conditions may be uploaded, and the process returns at step 6.48 to the process of FIG. 6A at step 6.16 as indicated, to re-run the underwriting engine. Alternatively, at step 6.50, it is determined whether the result was APPROVED/CONDITIONAL. If so, at step 6.52, a digital flood/title/hazard insurance appraisal is performed. At step 6.54, a quality appraisal is performed. At step 6.56, a fraud appraisal is performed. Once these extra steps are resolved and these materials are gathered and completed (as of step 6.40), the application is considered approved and the process proceeds on to the post-approval process of FIG. 6C at step 6.42. Alternatively, if the result was not SUSPENDED, DECLINED, APPROVED, SUSPENDED/CONDITIONAL, or APPROVED/CONDITIONAL, then it is determined at step 6.58 that the result was APPROVED/SUSPENDED/CONDITIONAL. At step 6.60, smart fees are required. At step 6.62, an assessment of compliance is performed. At step 6.64, eDisclosures (LE) are performed. There may be requirements to address here, such as at step 6.66 performing this action within three days of the application and at step 6.68 communicating intent to proceed. Again, with some extra steps performed, this APPROVED/SUSPENDED/CONDITIONAL can achieve approved status. Any application that reached step 6.42 is considered approved, and moves on to the post-approval process of FIG. 6C.

Referring now generally to the Figures and particularly to FIG. 6C, FIG. 6C is a third part of the second process chart of FIG. 6A, presenting steps of a post-approval process. It is noted that, while most of the benefit of the presented invention is discussed as pertaining to the steps of assembling the materials necessary to assess a loan application, the process doesn't end once the materials have been gathered and there is still a lot of coordination to be done in the remaining closing process, such as maintaining communication between parties, performing required building inspections, paying out the loan that was approved and setting up a future payment plan, and so on, and further noted that a circumstance such as the COVID-19 Pandemic has revealed how the process can be further complicated by having to do remotely and contact-free what was usually done in person, but also how the process might be optimized to reduce reliance on in-person transactions as an option for better flexibility and convenience all around. At step 6.70, the process starts. At step 6.72, it is determined whether there are any changes in circumstance, at at step 6.74, these are disclosed within the required three days if so. It is noted that, though this only appears as a ‘check’ once, if relevant circumstances change at any point in the post-approval process, this has to be disclosed within the three days. At step 6.76, documents are eSigned utilizing Remote Online Notarization (RON); at step 6.78 it is noted that this may be a hybrid eClosing process, such as in person with limited Power of Attorney. At step 6.80, funds are wired. At step 6.82, there is a digital review of the signed closing documents. At step 6.84, the loan is funded. At step 6.86, if rescission is required, there is a wait of three days prior to funding the loan. At step 6.88, the applicant may be requested to fill out a customer survey. At step 6.90, the process ends.

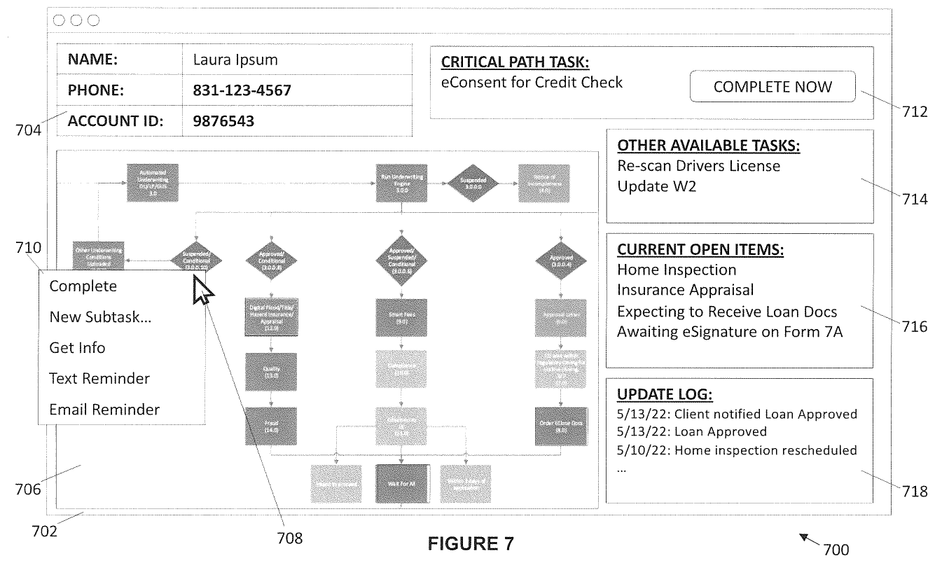

Referring now generally to the Figures and particularly to FIG. 7, FIG. 7 is a drawing of a possible layout for a graphical user interface (GUI) associated with practice of the invented method. A graphical user interface 700 (“the GUI 700”) may be displayed in a window 702 on a computer screen. It is noted that graphical displays vary based on one's computer or device operating system, and this example assumes a desktop-style operating system such as might appear on a PC or laptop. The standard title bar at the top and three buttons in the upper-left corner of the window are an aesthetic choice drawn as parts of a standard application window familiar to a viewer, suggesting as an example the interface of almost every application window interface in Mac OSX; Windows users may be more familiar with the same trio of buttons being mirrored on the right-hand side of the title bar instead. It is noted that, while a window frame and title bar are presented here, the GUI 700 may also have a fullscreen option. The GUI 700 for a software program managing one or more loan applications in accordance with the invented method might include, in a display pertaining to one particular selected loan application, some of the following exemplary elements as displayed here: a profile display 704, a graphical representation of the schema 706, a cursor 708 which can be used to select or act upon elements of interest, a drop-down menu 710 which might appear when certain elements are selected by the cursor such as with a right-click, a critical path display 712, a task list 714 containing open tasks the user could complete besides the critical path task, an open items list 716 containing all open tasks or paths, and a history log 718 enumerating completed items. The profile display 704 may present relevant ‘quick view’ application details such as, as presented here, the applicant's name, contact, and a unique ID number for identifying the application. It is noted that in this example, all text is arbitrary filler, starting with the fictional applicant name of “Laura Ipsum”, which is a pun on the well-known standby filler text passage beginning with the words “lorem ipsum”. The graphical representation of the schema 706 may comprise or include a graphical representation of steps in a loan application, such as the process charts presented in FIG. 5A through 6C, such that the user can locate the present application's progress within a visual ‘map’. The drop-down menu 710 is a graphical representation of interaction with the objects of the interface, including the option of interacting with elements of the graphical representation of the schema 706. In this example, the options presented include marking an item as complete (this may be an admin-only option not available to all users), creating a sub-task associated with this main task already instantiated, viewing more info about this task, or sending or setting a reminder, such as via text or email. This could be a ‘gentle nudge’ to another party, or even a self-reminder feature for the user. It is to be understood that these options and interface represent some possible examples of useful features and elements to include in the GUI 700, and nothing stated herein regarding features of the GUI 700 should be considered limiting except as codified in the claims. The critical path display 712 might serve the purpose of presenting the current next item in a critical path as determined in a process such as that of FIG. 12 and even providing an easily-accessible interface for completing that item now rather than ‘soon’, such as a button as shown. At least part of the benefit of providing an interface such as the GUI 700 is cutting through the ‘complexity’ and presenting a human user with clear, accessible, approachable actions to take when action is needed from them, such that less time and effort is spent figuring out what's going on or what needs to be done. It is noted that different users might be presented with different interfaces; for instance, the next critical task for the applicant might be to provide a scan of the applicant's driver's license, and the next critical task for the admin might be to ask the applicant for that scan, or even to move another path forward such as by performing a credit check. The task list 714 is another element that might usefully differ between users, with the applicant presented only with tasks they can do to move the process along, while an admin such as a loan agent might have a different list of tasks relevant to their side of the operation. The open items list 716 might be considered a listing of all the tasks that can be done by anyone to move the process forward, such that an admin can see, not just what would be useful for them to do, but what they may be waiting on from other contributors such as the applicant. The history log 718 might provide a listing of what items have been completed and when; this may be useful also as a full listing accessible via a button (not shown), and as a smaller ‘heads-up display’ listing (as shown) of the few most recent actions so someone logging in might see ‘what's new’ since they last checked on this application. Again, it's emphasized that only the claims are a limitation on possible interface features, and many of these features are presented as examples of ideas for useful aspects of a complete graphical user interface experience in general. It is further noted that additional interface options not presented here may include but aren't limited to: accessing a gathered item via this interface, such as clicking on a piece of the schema and opening the PDF of a scanned document gathered to complete that step; having the ‘overview interface’ present ‘short lists’ of recent developments or top tasks with longer listings available through navigating to a different screen; an interface presenting the ‘logic’ of how the present critical path was determined and why this is considered the best task to get done ASAP; interfaces for adjusting this logic; and more.

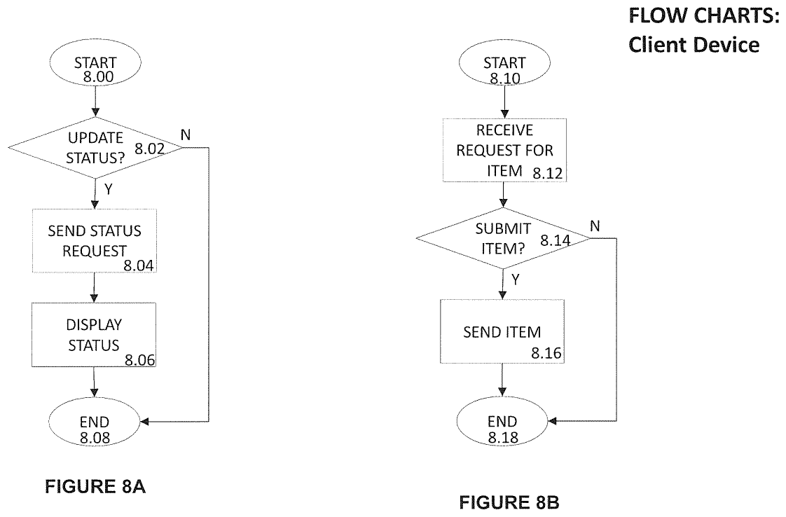

Referring now generally to the Figures and particularly to FIG. 8A, FIG. 8A is a first flow chart from the perspective of the client device 102 of FIG. 1, wherein the client device 102 queries the current status of an application. This might be a communication over the network 100 wherein the client device 102 requests a status report and the admin device 104 or an affiliated server such as the database server(s) 110 sends back a formatted status report data file to the origin of the request. This may also be something less transactional and more fluid, such as a user of the applicant device accessing a web page or online service via the network 100 that may require a login then present the user with an interface presenting the application status, such as the interface of FIG. 7. Another possible format might be a constant ‘drip’ of periodic updates, such that anytime a user may wish to look at the current status, that information is already available on the client device 102. One skilled in the art will recognize that, different as these example scenarios may seem, it's all just network traffic, and the key elements are providing of a network communication connection (such as the network 100) to request information and send information as requested, and providing an interface such that the user can understand the received data. At step 8.00, the process begins. At step 8.02, it is determined whether to request a status update. If so, at step 8.04, a status update request is sent to a relevant network device. At step 8.06, status information is received and displayed for the user. At step 8.08, the process ends.

Referring now generally to the Figures and particularly to FIG. 8B, FIG. 8B is a second flow chart from the perspective of the client device 102 of FIG. 1, wherein the client device 102 receives a request for a piece of information, and supplies the requested item. It is noted that in some instances, such as the ‘website’ example of FIG. 8A, the functions of receiving a status update and interacting with the application to provide further items may be part of the same interface or user experience, rather than distinct transactions as presented in the flow charts of FIGS. 8A & 8B. Again, it is noted that broken down to essentials of ‘just network traffic’ as one skilled in the art might consider it, the distinction in user experiences between ‘interacting with a website’ and ‘sending packets over the internet’ is illusory and irrelevant. The process begins at step 8.10; it is noted that there is no chronological order to the element steps of FIGS. 8A and 8B, and that the order of numbering is merely convenient for drafting based on order of appearance of these steps. In step 8.12, the client device 102 receives a request to provide an item required by the application, as managed by an instance of the schema 300; for instance, as an example used throughout, the loan application may require a scanned image of the applicant's driver's license, which can generally only be requested of the applicant (or someone else holding the applicant's driver's license) and might be requested by sending a communication to the client device 102 notifying the applicant to complete this item. At step 8.14, it is determined whether to submit the requested item, and if so, at step 8.16 the requested item is sent, generally to the network location which originated the request. It is noted that a condition of proper network security, such that this process occurs within a context where this request definitely came from the agency processing one's loan application and not just some shady random device somewhere on the internet attempting to gain access to this applicant's personal information for an unrelated reason, is generally understood to be included where relevant throughout these processes, even where not specifically stated, and that the processes described herein are generally assumed to be occurring between authorized devices and to be incorporating the unstated step of verifying that condition as considered necessary to good business practices of data security. In practicality, authorization might take the form of an authentication handshake, a password-protected login, a confirmation number only the applicant and the agency can provide, verification of a trusted sender, or other suitable authentication means as known in the art. It is further noted that good network security practices are not a limitation of the invention except as may be stated in the claims, and that the method might theoretically be practiced without any security measures on a closed local area network consisting only of trusted devices, but also acknowledged that if the invention is practiced on a more open network such as the internet, one skilled in the art would consider suitably strong network security measures necessary to any and all internet activity, not exempting safe, secure, and unimpeded practice of the invented method. At step 8.18, the process ends.

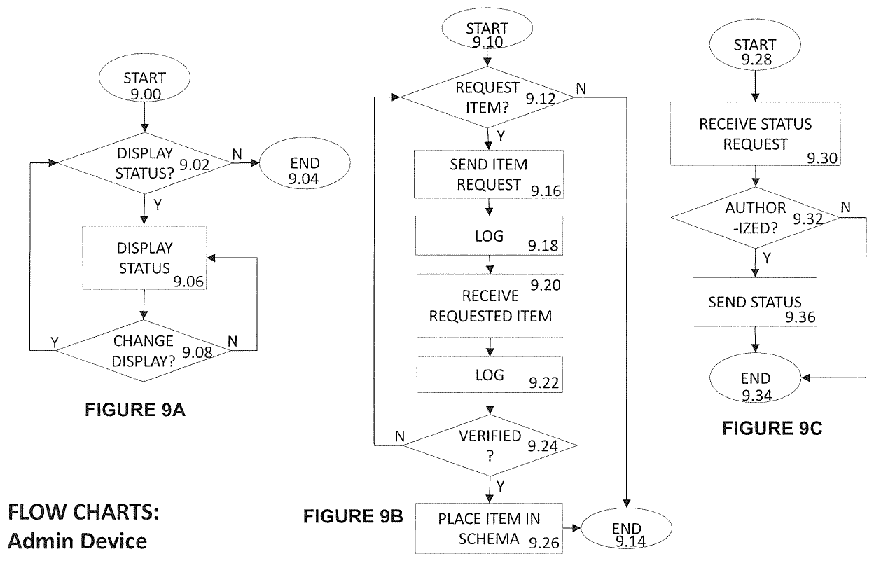

Referring now generally to the Figures and particularly to FIG. 9A, FIG. 9A is a first flow chart from the perspective of the admin device 104 of FIG. 1, wherein the admin device 104 generates a display of the present status of a specified application, such as the GUI 700. It is noted that this flow chart is sufficiently vague that this might be a displaying of the GUI 700 on a display component of the admin device 104 itself, such as on a display connected to the admin device 104 for an admin user such as a loan agent to see and interact with, or generation of an image for display on some other graphical interface, such as providing a webpage to send over the network 100 for display on the client device 102, such as in response to the data request of FIG. 8A. It is further noted that, while this flow chart is stated to be occurring on the admin device 104, this might be considered an instance of usage of the admin device 104 as representative of a loan office overall; in a larger office, the same single loan officer's work computer would be unlikely to also be the web server, the database server, etc. and these functions may be delegated to various database server(s) 110 with the understanding that these multiple computers collectively interact with the client device 102 as ‘the loan office’ and which computer does what within that cluster is only relevant to the loan office's sysadmin. In an environment such as this, an individual loan officer's work computer may similarly access a server storing data for their office to receive an interface containing information about a loan schema that agent might be working on. Therefore, in the context of the present flow chart, the admin device 104 is understood as the device having the task of providing to authorized parties status display data for loan applications on behalf of the managing loan office, such that a device such as a client device 102 looking for a status update would contact this network address. In step 9.00, the process begins. In step 9.02, it is determined whether to display a current status; in subsequent loops, this could also be an update check. If a status is not being displayed, in step 9.04, the process ends. If so, in step 9.06, a current status is displayed. In step 9.08, it is determined whether to continue showing the current display, or to display the status a different way; this might be an alteration of the view options of the GUI 700, or a status change originated by the viewer, such as interaction with the GUI 700. It is noted that this flow chart presents display of the status as an ongoing loop, such that the loop continues while the status is being displayed.

Referring now generally to the Figures and particularly to FIG. 9B, FIG. 9B is a second flow chart from the perspective of the admin device of FIG. 1, wherein the admin device 104 requests and receives an item from another device in the network 100. It is noted that the flow chart of FIG. 9B can be viewed as an opposite side of the interaction of the flow chart of FIG. 8B, with FIG. 9B requesting an item, FIG. 8B responding to the request and sending the item, and FIG. 9B receiving the sent item and filing the item appropriately. At step 9.10, the process begins; it is noted that there is nothing chronological about the element numbering sequence, and the processes of the Figures might occur in any order except where these might interact with each other. At step 9.12, it is determined whether to request an item, such as a required document for completing or advancing a loan application schema such as an instance of the schema 300. If not, the process ends at step 9.14. If so, at step 9.16, a request for the item, such as an instance of the query 400, is sent to a relevant party which might provide the item, such as the client device 102 or the information source device(s) 106. At step 9.18, this transaction might be logged; it is noted that regular system logging is generally a good practice, particularly in an automated system doing customer service and handling sensitive financial documents, and also that it may be useful for a loan agent to be able to check a history of whom has been contacted for what and when, to both make sure essential information was communicated timely and minimize unnecessary annoying of customers with repeated communications. Logging isn't considered absolutely essential as a feature, but is considered a good idea, enough to be represented in at least one flow chart herein to show anticipation of best practices; it is understood that other logging may and probably should occur besides the instances of logging specifically mentioned herein. In step 9.20, the requested item is received; there may be some delay before this occurs, as supplying the item is an action to be performed by the queried party. At step 9.22, receipt of the item may also be logged. At step 9.24, the item is checked to ensure completeness; for instance, if a scanned form was received but it's the wrong form, or missing a signature, or something wasn't filled in (as we all know, these things happen), then the request was not actually fulfilled by receipt of what was sent, and another request may need to be made to correct what was sent. If the item is correct, then at step 9.26, the received item is ‘filed’ in the schema 300 associated with the present application, such that that step is registered as complete.

Referring now generally to the Figures and particularly to FIG. 9C, FIG. 9C is a third flow chart from the perspective of the admin device of FIG. 1, wherein the admin device receives and responds to a request to transmit the present status of an application to another device on the network. It is noted that FIG. 9C might be viewed as a counterpart and opposite side of the interaction to FIG. 8A, with FIG. 8A requesting a status update, FIG. 9C receiving and authenticating that request and providing the requested information, and FIG. 8A receiving the update and displaying the information. At step 9.28, the process starts. At step 9.30, a request for a current status is received. At step 9.32, it is determined whether the request is authorized; this may be considered a non-comprehensive nod to the principle as understood by one skilled in the art of being scrupulous about network security when handling sensitive personal data such as social security numbers and financial information, and ensuring that only certain such requests for information will receive informative responses. Authorization might be determined by any suitable means as known in the art generally for restricting or authenticating access to a network or computing system, such as but not limited to requiring a user to enter a previously-supplied password or confirmation number, or checking for a certain prearranged networking protocol or ‘handshake’ between authorized computers. If the request is not authorized, the process ends at step 9.36 without a response to the unauthorized request (it is noted that further securing actions, such as reporting an unauthorized access attempt, are not represented here and might be built in at a sysadmin or security expert's discretion). If appropriate, at step 9.34, the requested status information is sent in response to the request. It is noted that, while this chart specifically represents verification of authorized access and other charts herein may not, that this kind of verification might be inserted into the processes presented herein anywhere that one skilled in the art might consider necessary to ensure and practice good network security.

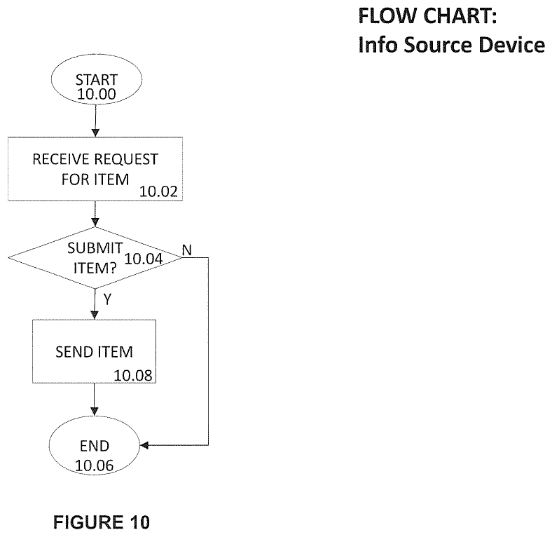

Referring now generally to the Figures and particularly to FIG. 10, FIG. 10 is a flow chart from the perspective of one of the information source devices 106 of the network of FIG. 1, wherein the information source device 106 receives and responds to a request for a piece of information. It is noted that this is the same function presented in FIG. 8B as practiced by the client device 102, and this flow chart of FIG. 10 is presented for the sake of completeness, showing the information source device 106 side also. It is noted that the information source device(s) 106 might, as previously mentioned, be any device or server on the network 100 that gets contacted to obtain a piece of data for completing the application; some examples might include a server that runs credit checks or authenticates a scanned driver's license, or even contacting a human user at a third-party firm to complete a task like a non-automated credit check or other necessary service. It is further noted, though previously mentioned as well, that the formatting or content of the instance of the query 400 sent as a request for information via the network 100 may be different depending on what kind of service is being interacted with; it may be an auto-generated email to a human respondent, or filling in of a digital form or formatting of a data packet to request or direct automated performance of a task by a server, or something else. At step 10.00, the process begins. At step 10.02, a request is received for an item. At step 10.04, it is determined whether or not to submit the requested item; if not, the process ends at step 10.06. If so, the item is sent as requested at step 10.08.

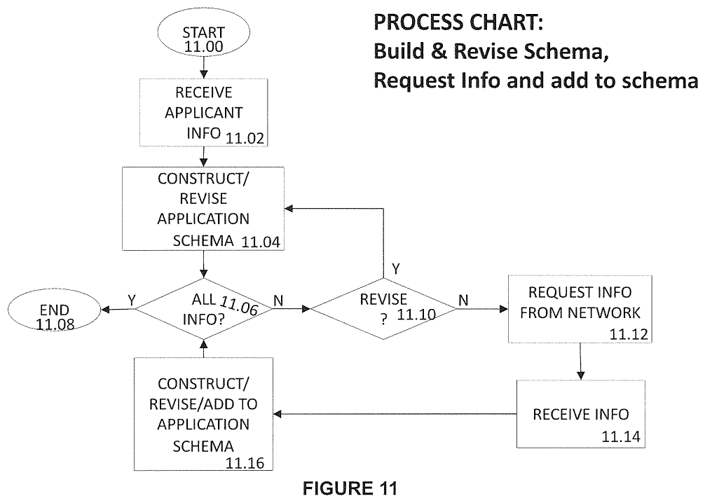

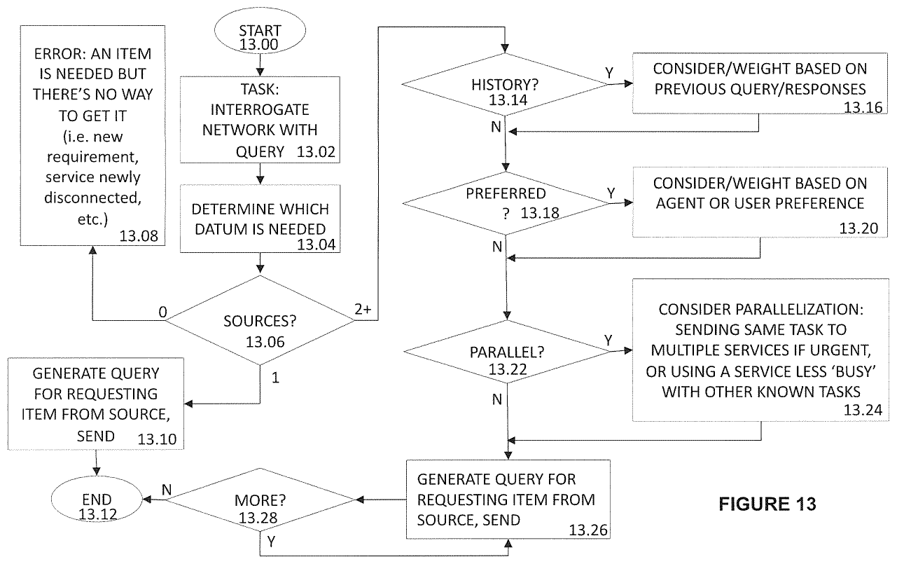

Referring now generally to the Figures and particularly to FIG. 11, FIG. 11 is a process chart presenting an aspect of the invented method, wherein some selected instance of the schema 300 of FIG. 3 is built and revised based on initial and subsequent data input. At step 11.00, the process starts. At step 11.02, applicant information is received, such as initial information for initiating an application such as the applicant's name. In step 11.04, the schema 300 is constructed or revised to include the received information. At step 11.06, it is determined whether all information has been received for this schema 300; if so, the process may end at step 11.08. If not, at step 11.10, it is determined whether to further revise the existing information; if so, this work is done, and if not, but further information is still indicated, the network 100 is queried for further information; FIG. 13 presents more detail on this process. At step 11.14, further information as queried is received via the network 100. In step 11.16, this further information is added to the schema 300 and the schema 300 may be revised in view of this information.

Referring now generally to the Figures and particularly to FIG. 12, FIG. 12 is a process chart presenting an aspect of the invented method, wherein a critical path is determined based on certain criteria. It is noted that the term ‘critical path’ herein is used in the sense of a term of art used in software project management in particular, wherein everyone may be working on the same project or interrelated projects, but depending on other priorities or contingencies, or on one part of the project being unable to progress without another, one or another particular area of the project may become the ‘critical path’, the current most important area to make progress in; this area or pipeline may therefore be assigned more resources or monitored more closely. In this case, while the logic pipeline of loan applications (see FIGS. 5A-6C) may allow for several different routes through the process, some are more efficient than others, and often the relative efficiency depends on the applicant's situation, and can even change over time. Particularly because these processes are both laborious and time-sensitive, it's important to determine and be aware of the current critical path, that is, which items are most efficient or urgent to complete first or next. In step 12.00, the process begins. As of step 12.02, the task of determining at least one critical path for continuing with a particular loan application process as managed by a particular instance of the schema 300 is undertaken. In step 12.04, a listing of available open paths is compiled; the task is to select from these possible next actions to determine a preferred next action. At step 12.06, it is determined whether any of the options provided are time-sensitive; if a critical deadline window is closing, that item might be a shoo-in as the next top priority. If such an item is found, at step 12.08 that item is selected as the critical path and the process ends at step 12.10. Otherwise, a next criterion considered in determining critical path might be, at step 12.12, checking whether one of the available items or pathways will start a process that has a lengthy turnaround time, as it may be advantageous to start that sooner rather than later. At step 12.14, if such an item as this was found, that item might be selected as the critical path. In absence of any glaringly time-sensitive or urgent priorities, or even in their presence depending on the situation and the specifics of the algorithm presented only generally here, at step 12.16 the relative criticalness of different possible paths might be assessed by efficiency: that is, how direct these routes are toward a decisive result. If, for instance, the success or failure of an available item (e.g. failed credit check might equal failed application, but at least one finds out about it right away, rather than after doing a lot of redundant extra work) decides the success or failure of the whole application, it may be considered a critical path to get that high-stakes item out of the way and only pursue a less-direct and more laborious path if no more-direct path is available for decisively resolving the application. It is noted that, while a decisive denial of the application based on a received piece of information is probably easier to achieve in most cases than a decisive approval, pursuing the most critical path by prioritizing potential ‘easy no’s should not be interpreted as looking for reasons to deny the application, but rather reducing open paths and ruling out the easily-determined deal-breakers early, and only requiring further input where and as actually necessary to most efficiently and decisively determine the loan application outcome. It is noted that, depending on how the invented algorithm might weight potential available critical path options, a very decisive or efficient option may even outweigh a deadline that isn't urgent yet, or an item that may take some lead time but may not be necessary at all depending on the outcomes of quicker available steps; while this process chart presents these criteria as yes/no's that exclude each other, it should be noted that this is only one possible variation of such an algorithm and that order or implicit exclusion shouldn't be construed as limiting, but rather an enumeration of key criteria under consideration. Even if no path stands out as particularly or exceptionally urgent or efficient, there will always be a ‘shortest’ available path to a decisive result. In step 12.18, a critical path is selected based on being the shortest path to a decisive resolution of the application.

Referring now generally to the Figures and particularly to FIG. 13, FIG. 13 is a process chart presenting an aspect of the invented method, wherein an instance of the query 400 of FIG. 4 is generated and the network is interrogated with the generated query 400. In the context of practicing the invented method over the network 100, steps for resolving a loan application broadly consist of requesting and procuring required pieces of data. These may be required paperwork or items from the applicant, such as the applicant's social security number, a scanned copy of the applicant's driver's license, or an eConsent form signed by the applicant authorizing a credit check, or these may be steps that can be completed without asking the applicant for anything, but instead contacting other third parties, such as performing said credit check, verifying said driver's license, looking up said social security number, and so on. For more information about the specific steps of a loan application process as might be instantiated into the schema 300, please see FIGS. 5A-6C. Depending on the query 400 (i.e. the request for a certain item for completing a certain node 302), which part of the network 100 may be needed to complete the item may vary. This process chart presents a more detailed process of, given an item to complete, interrogating the available resources of the network 100 to complete that item. It is noted that this process might be practiced by the admin device 104 or another device in the office of the admin device 104 to which this legwork may be delegated, and that this process might be considered an aspect of managing, maintaining, and advancing the progress of the schema 300. In step 13.00, the process begins. As of step 13.02, the present task is to interrogate the network 100 with an instance of the query 400 in order to, if possible, obtain a datum required by some selected instance of the node 302 as included within some selected instance of the schema 300. In step 13.04, it is determined which datum is currently needed. As a practical example, suppose that there is a loan application currently in progress, tracked and managed by the schema 300 as mentioned, and the next requirement to be fulfilled is a credit check. It is noted that further detail regarding selection of ‘the next item’, within the context of assessing a critical path, is explained in FIG. 12; as of FIG. 13, it is assumed that (one way or another) there is a next requirement already selected, and what is being determined is how to utilize the resources of the network 100 to work on that already-established priority. In step 13.06, it is determined how many information sources are available on the network 100 that this datum might be obtained from; this might consist of starting with all network 100 connections then narrowing that down to just the relevant ones, or there might already be something like a stored list or directory to work from. If, concluding this process, there are 0 sources available, then at step 13.08 that's an error condition and a human user should probably be notified; this might indicate that this computer is disconnected from the network 100, that any supplied directory is inaccurate or invalid or may need updating, that sources such as third-party services that have been relied upon previously are now unavailable for some reason (for instance, that particular service provider went out of business and the human admin may need to find a new one), or even that there's a new requirement that has been added into the schema 300 that the rest of the system hasn't been told how to handle. Otherwise, if there's only one source that can answer the current requirement, no selection process is required; at step 13.10 an instance of the query 400 appropriate to querying that source for the required datum is composed, and is sent to the relevant information source, which may, depending on what datum is needed, be the client device 102 or one of the plurality of information source servers 110. For example, if the required datum is a scan of the applicant's driver's license, then the client device 102 might well be the only available source for supplying that datum, and the query 400 may be formatted as an email reminder to the applicant to scan and submit their driver's license; similarly, there may be only one information source server in the plurality of information source servers 110 that can respond to a certain query 400, either an obscure service that the admin office only has one provider for currently, or an agency such as the DMV or the IRS. It is noted that the admin device 104 may also be a source; for instance, a step may require data entry or validation by a human loan agent, and the corresponding query may be in the form of a pop-up window on that computer screen or an email or notification to that agent prompting attention to this application. Once the one query 400 is sent to the one selected source (it is noted that multiple queries could be sent, as described in step 13.24, and while not ruling this out, it is noted that a plurality of queries sent to the same source at the same time regarding the same matter could be both redundant and obnoxious), the process ends at step 13.12. If there are two or more information sources that might be able to fulfill the current task, then a selection process may occur, such as but not limited to the process of steps 13.14 through 13.22, to select at least one source from the plurality available to query for the sought information. In step 13.14, it is determined whether to consider history, such as whether this source has been responsive to previous queries and the quality of those responses; for instance, one credit check service may be found to be more reliable or prompt than another. At step 13.16, if indicated, such factors are considered: a best option may be selected, some worst options may be ruled out, or a plurality of options may be weighted or rated based on this decision factor. At step 13.18, it is determined whether to consider a set preference in determining which source to query; for instance, in some cases it may be possible to complete a task either by querying an automated service or asking a human user, and a set preference to only request a human user's attention when there's no automated alternative might be a logical limitation to impose here. Further, a loan agent business may prefer to use a certain specific other business's service that they're friendly with professionally, or may prefer as a matter of general policy to give work to small or local businesses providing the required service as they're able to do so; this might be considered a placeholder for that kind of preference to be codified as a program setting for the process to operate under. In step 13.22, it is determined whether parallelization of tasks should be considered, and in step 13.24, this aspect is considered. If the task at hand is urgent, one available option might be to query multiple sources, as some may be more responsive than others. Another way parallelization might be considered is as follows. If the same loan agency manages over a hundred applications at once, and has a ‘favorite’ credit check service, for instance, then that credit check service will be getting a lot of traffic all at once from the same place, and the agency's applications would all be stuck waiting in the same queue, so to speak. Since the loan agency's system knows about other query traffic from other applications, though, this agency might consider spreading out that work-load over multiple selectable credit check services, parallelizing and thus optimizing their own operation. Step 13.24 accounts for considering these kinds of strategies in determining which source or sources to query for this piece of information. In step 13.26, an instance of the query 400 is generated which is suitable for querying the source that was selected, and sent. In step 13.28, a loop of sending multiple queries 400 to multiple selected sources is accounted for. And once there are no more queries to send, the process ends at step 13.12. It is noted that receiving the response or responses to these queries isn't covered here, and FIG. 9B provides a broader overview of a full ‘send query then receive response’ process.

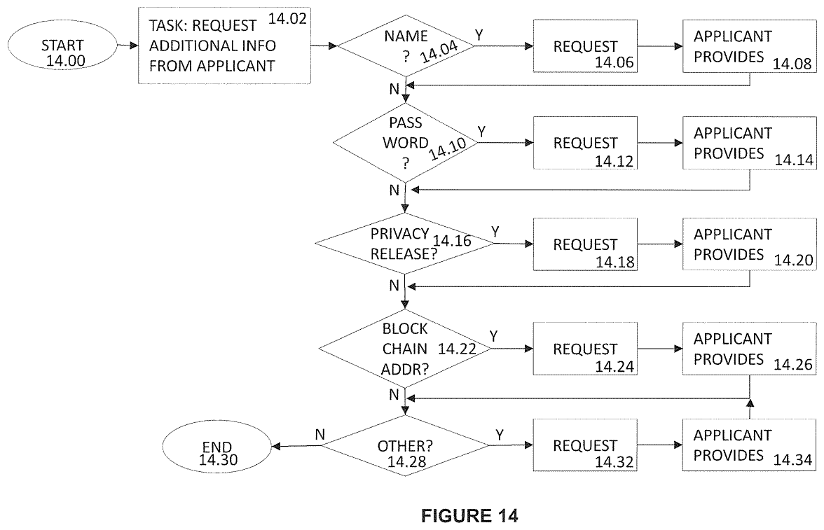

Referring now generally to the Figures and particularly to FIG. 14, FIG. 14 is a process chart presenting an aspect of the invented method, wherein additional information is requested and received from the applicant. The process starts at step 14.00. At step 14.02, the task is undertaken of requesting additional information from an applicant in the process of applying for a loan in accordance with the method presented herein. At step 14.04, it is determined whether to request the applicant's name. If so, then at step 14.06, the applicant's name is requested, and at step 14.08, the applicant's name is provided by the applicant. At step 14.10, it is determined whether to ask the applicant to select or provide a password. If so, then at step 14.12, the password is requested, and at step 14.14, the password is provided by the applicant. At step 14.16, it is determined whether to request that the applicant complete a privacy release. If so, then at step 14.18, the privacy release is requested, and at step 14.20, the completed privacy release is provided by the applicant. At step 14.22, it is determined whether to request a blockchain address. If so, then at step 14.24, the blockchain address is requested, and at step 14.28, the blockchain address is provided by the applicant. At step 14.28, it is determined whether to request other information not otherwise listed in this chart. If so, then at step 14.30, the other item is requested, and at step 14.32, the other item is provided by the applicant. It is noted that following step 14.34 the process loops back to step 14.28, allowing for an indeterminate number of possible ‘other’ pieces of information to be requested. When there are no more pieces of information to be requested, the process ends at step 14.30.

While selected embodiments have been chosen to illustrate the invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

We claim:

1. In an information technology network (“the network”) comprising a plurality of database servers, a user system, and a query system, a method comprising:
a. Receiving a plurality of preliminary applicant information related to an applicant for a real estate mortgage;
b. Instantiating a loan application schema (“the schema”) comprising a plurality of information nodes, each node adapted to receive a particular datum of a diverse plurality of information;
c. Deriving at least one query from the applicant information, the at least one query formatted to request at least one particular datum of a selected one node;
d. Interrogating the network with the query;
e. Securing the at least one particular datum via the network; and
f. Populating the selected node with the at least one particular datum.

2. The method of claim 1, further comprising:
g. Indicating to the applicant via the user system of an additional datum not yet received by the query system.
h. the applicant providing an additional information directed to securing the additional datum;
i. the query system deriving an additional query formatted to request the additional datum;
j. Interrogating the network with the additional query;
k. Securing the additional datum via the network; and
l. Populating an additional node with the additional datum.

3. The method of claim 1, wherein the indication to the applicant via the user system of the additional datum not yet received by the query system is performed via a graphical user interface made accessible to the applicant.

4. The method of claim 3, wherein the graphical user interface is made accessible to a third party as a read only access.

5. The method of claim 3, wherein the indication to the applicant comprises a coloring of a visual representation of the additional node.

6. The method of claim 3, wherein a plurality of nodes is represented within the graphical user interface.

7. The method of claim 3, wherein the indication to the applicant via the user system of a fulfillment status of each of a plurality of nodes is made visible via the graphical user interface made accessible to the applicant.

8. The method of claim 6, wherein each node of schema is represented within the graphical user interface and made accessible to the applicant and each fulfillment status of a plurality of nodes are visually distinguished.

9. The method of claim 3, wherein the schema is represented within the graphical user interface and made accessible to the applicant.

10. The method of claim 2, wherein the additional information comprises an account identifier.

11. The method of claim 2, wherein the additional information comprises an authorization.

12. The method of claim 2, wherein the additional information comprises a privacy release authorization.

13. The method of claim 1, wherein the query system revises the schema on the basis of preliminary applicant information.

14. The method of claim 2, wherein the query system revises the schema on the basis of additional information.

15. The method of claim 1, further comprising:
g. the query system determining a critical path datum not yet received by the query system; and
h. Indicating to the applicant via the user system regarding the critical path datum.

16. The method of claim 14, wherein the critical path datum is a determinative datum, wherein a received value of the datum is determinative of a loan application process.

17. The method of claim 14, wherein the critical path datum is selected in view of an expected lead time to receive the additional datum.

18. The method of claim 1, further comprising indicating to the applicant via the user system of a plurality of additional data not yet received by the query system.

19. The method of claim 18, wherein the indication to the applicant via the user system of the plurality of additional data not yet received by the query system is performed via a graphical user interface made accessible to the applicant.

20. The method of claim 2, wherein the network further comprises a blockchain and the additional information further comprises a blockchain memory address.

21. An information technology network (“the network”) comprising a plurality of database servers, a user system, and a query system, the network adapted to instantiate the method of claim 1.
